(19) United States
(12) Patent Application Publication
(10) Pub. No.: US 2023/0074483 A1
(43) Pub. Date: Mar. 9, 2023

(54) MEMBRANES FOR THE TARGETED EXTRACTION OF PHOSPHATE

(71) Applicant: The Regents of the University of California, Oakland, CA (US)

(72) Inventors: David Jassby, Los Angeles, CA (US); Arpita Iddya, Los Angeles, CA (US); Eric M.V. Hoek, Los Angeles, CA (US)

(21) Appl. No.: 17/903,567

(22) Filed: Sep. 6, 2022

Related U.S. Application Data
(60) Provisional application No. 63/240,682, filed on Sep. 3, 2021.

(51) Int. Cl. B01J 47/12; B01J 39/18; B01J 39/05; B01J 47/018

(52) U.S. Cl. CPC B01J 47/12; B01J 39/05; B01J 39/18; B01J 47/018

(57) ABSTRACT

An ion exchange membrane includes nanoparticulate hydrous manganese oxide, wherein, the ion exchangemembrane is selective for the passage of phosphate ion. Methods of preparing ion exchange membranes and methods of seprating phosate also are described.

### CROSS-REFERENCE TO RELATED APPLICATIONS

This application claims the benefit of priority to U.S. Provisional Application No. 63/240682 filed on Sep. 3, 2021, the contents of which are hereby incorporated by reference in their entirety.

### GOVERNMENT RIGHTS

This invention was made with government support under Grant Number 2017-67022-26135, awarded by the U.S. Department of Agriculture. The government has certain rights in the invention.

### FIELD

The present disclosure generally relates to ion exchange membranes. Specifically, it is related to ion exchange membranes for the selective passage of phosphate ion.

### BACKGROUND

Phosphorus is an important nutrient required for plant and animal growth, however, excess of this nutrient in water bodies leads to eutrophication, which further leads to depletion in dissolved oxygen content in water and decline in aquatic life. As a result, continuous efforts have been made at developing technologies to remove phosphate from wastewater streams. Moreover, with the increasing demand for phosphate and ever declining phosphate reserves, it has become imperative to recover the nutrient as well during removal.

One of the methods for phosphate sequestration is adsorption of phosphate onto sorbents. This method allows for phosphate removal and recovery by changing the pH conditions of the solution around the sorbent. However, this adds a step to phosphate recovery as it is not a continuous process and requires constant changes in pH to release the sorbed phosphate.

A continuous process for phosphate recovery would entail translating the adsorption-desorption process onto a membrane process. However, transport of target species across a membrane is dependent upon either size exclusion or charge exclusion, and few or no membranes exist that are highly selective for a particular ion species.

### SUMMARY

The present disclosure provides an ion exchange membrane comprising a cation exchange membrane having hydrous manganese oxide nanoparticles incorporated therein.

In some embodiments, the ion exchange membrane comprises from about 25 to about 250 mg of manganese per gram of the cation exchange membrane, while in other more particular embodiments, the ion exchange membrane comprises from about 50 to about 150 mg of manganese per gram of the cation exchange membrane.

In some embodiments, the hydrous manganese oxide nanoparticles have an average particle size of from about 25 to about 250 nanometers. In other embodiments, the hydrous manganese oxide nanoparticles have an average particle size of from about 50 to about 150 nanometers.

In some embodiments, the ion exchange membrane comprises a gel phase and an intergel phase.

In some embodiments, the ion exchange membrane comprises pores.

In some embodiments, the ion exchange membrane is selective for the passage of phosphate ion. More particularly, in some embodiments, the ion exchange membrane is selective for the passage of phosphate ion under concentration-driven conditions or field-driven conditions. For example, in some embodiments, the ion exchange membrane is at least 30 times more selective for phosphate over chloride, nitrate, or sulfate.

In some embodiments, the cation exchange membrane comprises a) a polymeric backbone having anionic groups attached thereto, and b) positive counterions. In particular embodiments, the anionic groups are covalently bound to the polymeric backbone. In more particular embodiments, the anionic groups comprise sulfonate ions.

In some embodiments, the cation exchange membrane comprises cations selected from Li, Na, K, Mn, Cs, and any combination thereof.

In other aspects, a method of making an ion exchange membrane comprising hydrous manganese oxide nanoparticles comprises the steps of:
a) exposing a cation exchange membrane to an aqueous solution comprising manganese ions;
b) exposing the cation exchange membrane to an alkaline oxidizing solution, thereby forming the ion exchange membrane comprising hydrous manganese oxide nanoparticles;
c) washing the ion exchange membrane comprising hydrous manganese oxide nanoparticles with an aqueous washing solution to achieve a neutral pH.

In some embodiments, step b) incorporates the hydrous manganese oxide nanoparticles into the cation exchange membrane.

In some embodiments, the alkaline oxidizing solution comprises aqueous NaOH and NaOCl.

In further embodiments, the aqueous washing solution is water.

In some embodiments, the method further comprises drying the ion exchange membrane after step c).

Also provided herein is a method for separating phosphate ions from a first aqueous solution comprising phosphate ions and non-phosphate ions, the method comprising:
contacting the first aqueous solution with a first side of an ion exchange membrane described herein;
contacting a second aqueous solution with a second side of the ion exchange membrane; and
applying a potential to a circuit comprising the first and second aqueous solutions such that phosphate ions flow from the first aqueous solution through the ion exchange membrane and into the second aqueous solution.

In particular embodiments, the phosphate ions flow selectively from the first aqueous solution to the second aqueous solution.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustrating t diffusion cells operated in a concentration-driven (Donnan dialysis) or concentration + field-driven (electrodialysis) modes.

FIGS. 2A and 2B are photographs of an unmodified CEM and an exemplary HMO-CEM, respectively. FIGS. 2C and 2D are cross-sectional TEM micrographs for an unmodified CEM and an HMO-CEM, respectively. FIGS. 2E and 2F show, respectively, XPS spectra and FT-IR spectra for an unmodified CEM and an exemplary HMO-CEM.

FIGS. 3A-3D are graphs of A) of normalized phosphate concentration and pH;; B) Phosphate selectivity over competing anions for an unmodified and HMO-CEM; and change in normalized concentration (C/Ci) in the permeate for the (C) unmodified CEM, and (D) HMO-CEM for an equimolar solution, according to the examples.

FIGS. 4A-4D are: A) a molecular dynamics simulation of a spherical HMO particle embedded in the ion exchange polymeric matrix saturated with an aqueous solution containing H₂PO₄⁻ and Na⁺ ions; B) a the simulation cell with water molecules and Na⁺ ions hidden; C) a graph of voltage-dependent diffusion coefficients of ions in the gel phase; and D), a depiction of outer-spherically adsorbed H₂PO₄⁻ ions on the surface of a HMO particle, according to the examples.

FIGS. 5A and 5B are graphs comparing experimental values and model predictions for A) phosphate flux and B) phosphate transport number, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Facilitated transport provides a possible mechanism for transport of selective molecules across a membrane interface. The process involves transport of solute across a membrane due to combination of a solution-diffusion mechanism combined with a complexation reaction. The complexation reaction is similar to chemical adsorption of solute on feed side and stripping on permeate side. Transition metal cations for example, Zr, Cu, and Fe, which have hard Lewis acid properties, exhibit preferential adsorptive selectivity toward phosphate. Manganese dioxide, on the other hand, forms outer sphere complexes, which could allow for ion hopping between manganese dioxide molecules. While not being bound by theory, encapsulating manganese dioxide as hydrous manganese dioxide within a cation exchange membrane allows phosphate adsorption and transport across the membrane, while other anions are excluded due to co-ion repulsion.

Accordingly, in some embodiments, an ion exchange membrane comprises a cation exchange membrane (CEM) having hydrous manganese oxide (HMO) nanoparticles incorporated therein.

The ion exchange membrane (also referred to herein as HMO-CEM) comprises, in some embodiments, from about 25 to about 250 mg, about 50 to about 250, about 50 to about 200, about 50 to about 150, about 50 to about 100, about 100 to about 250, about 100 to about 200 or about 100 to about 150 milligrams of manganese per gram of the cation exchange membrane.

In some embodiments, the hydrous manganese oxide nanoparticles have an average particle size of from about 10 to about 500 nanometers, about 25 to about 250 nm, about 50 to about 250 nm, about 50 to about 200 nm, about 50 to about 150 nm, or about 50 to about 100 nm.

The ion exchange membranes described herein, in some embodiments, comprises a gel phase and an intergel phase. In further embodiments, the ion exchange membrane is porous. For example, the ion exchange membrane may comprise micropores, mesopores, macropores, and combinations thereof. Without being bound by theory, it is believed that the negatively charged polymeric matrix of the cation exchange membrane ensures the flow of H₂PO4- ions across the membrane until the HMO particle is encountered. The weak outer-sphere complexes _{H2PO4}-/HMO are formed within the Stern part of the electrical double layer (EDL), which are relatively mobile and can migrate around HMO particle if subjected to external driving force like flow or weak electric field. The H₂PO₄ions jump from one HMO particle to another through the intergel solution phase, that is, through the fluid-saturated micro, meso, or macropore spaces. The phosphate ions adsorbed to HMO diffuse within the particle EDL in the direction of the flow or applied electric field.

The ion exchange membranes described herein are advantageously selective for the passage of phosphate ion under concentration-driven conditions or field-driven conditions. Here, we report a phosphate-specific, reverse selectivity in cation exchange membranes. While not being bound by theory, the in-situ growth of hydrous manganese oxide (HMO) nanoparticles (NPs) throughout a cation exchange membrane material provides a diffusion pathway for phosphate, via reversible outer-sphere interaction. Other competing anions do not form these interactions with the NPs, and are prevented from passing through the membrane by the fixed negative charges of the polymer backbone. Upon incorporating the HMO NPs, the membrane’s phosphate permeability is greatly increased (e.g. on the order of 30 times) compared to an unmodified membrane. In some embodiments, the ion exchange membrane is at least 20, 30, or 40 times more selective for phosphate over other anions, such as chloride, nitrate, or sulfate. In particular embodiments, the ion exchange membrane has an improved selectivity of 42, 37, and 43 for phosphate over other competing anions such as sulfate, nitrate, and chloride, respectively.

Ion selective separation membranes are used in clinical, environmental, food, and analytical applications. However, despite their extensive use, high-precision separations using membranes remains a challenge. Fine-tuning the selectivity of membranes could increase the efficiency of existing applications. (1) Increasing demand for resources and the depletion of natural reserves have made it imperative to find alternate sources and technologies to meet the growing need of a modern society.(2) For instance, deposits of phosphorus and potassium, important ingredients in fertilizers, are expected to be significantly depleted by the end of the century.(3, 4) However, few reports on membranes that are exclusively selective towards specific anions such as phosphate exist.(3-8) In addition, while phosphate is almost always mined, the continuous extraction of phosphate ions from waste streams (such as municipal wastewater) would enable simultaneous treatment of an environmental contaminant responsible for water eutrophication and production of a valuable commodity chemical.(9-12)

Facilitated transport membranes (FTM) have been used to increase the selectivity of membranes towards specific targets by pairing the target molecule with “extractant” particles/functional groups embedded within a membrane matrix.(13-15) These extractants selectively bind with the target molecule or ion to form a complex, and transport of the target is then facilitated by either the motion of the complex (mobile carrier FTM) or hopping of the target from one carrier to another (fixed carrier/fixed-site FTM).(14) For ion separation, facilitated transport has been demonstrated using polymer inclusion or liquid membranes, but they suffer from poor stability.(16, 17)

The present ion exchange membranes advantageously allow facilitated transport of target ions through specific outer-sphere interactions between the target and an inorganic component within the membrane. Many transition metals, such as Zr, Cu, and Fe, have hard Lewis acid properties and exhibit preferential adsorptive selectivity toward phosphate.(18, 19) Hydrous manganese oxide (HMO) has also been demonstrated to be an effective phosphate sorbent.(12, 20-22) However, unlike other transition metals, HMO forms weaker outer-sphere complexes with phosphate, which can allow for phosphate ion hopping between adjacent manganese (di/hydro)oxide groups.(21, 23) Embedding HMO NPs throughout a Cation Exchange Membrane (CEM) containing multiple fixed negative charges (e.g., from sulfonate groups) attached to the polymer backbone, creates a diffusion pathway for phosphate across the polymer matrix. Other anions (e.g., C1⁻, NO₃⁻, SO₄⁻²) that do not form complexes with HMO are denied passage due to charge exclusion forces exerted by the CEM’s fixed negative functional groups.

In some embodiments, the ion exchange membrane comprises a) a polymeric backbone having anionic groups attached thereto, and b) positive counterions. In particular embodiments, the anionic groups are covalently bound to the polymeric backbone. In some embodiments, the anionic groups comprise sulfonate ions. In further embodiments, the ion exchange membrane comprises the positive counterions selected from cations of Li, Na, K, Mn, Cs, and any combination thereof.

In other aspects, a process for preparing an ion exchange membrane comprising hydrous manganese oxide nanoparticles is provided. In some embodiments, a method of making an ion exchange membrane comprising hydrous manganese oxide nanoparticles comprises the steps of:
a) exposing a cation exchange membrane to an aqueous solution comprising manganese ions;
b) exposing the cation exchange membrane to an alkaline oxidizing solution, thereby forming the ion exchange membrane comprising hydrous manganese oxide nanoparticles; and
c) washing the ion exchange membrane comprising hydrous manganese oxide nanoparticles with an aquous washing solution to achieve a neutral pH.

Generally, hydrous manganese oxide (HMO) is loaded into a commercial cation exchange membrane by immersing a cation exchange membrane, in its dry form, in a manganese containing solution such that the manganese ions replace a portion of the cations on the cationic exchange membrane. The manganese ions are then subjected to oxidation under basic conditions, followed by washing, for example with water, until a neutral pH is achieved. A neutral pH is a pH of about 6 to about 8, about 6.5 to about 7.5, or about 7. An oxidation solution was prepared by dissolving NaOH into Clorox® (NaOCl) solution to prepare a 1M NaOH solution with about 7% available chlorine. The loaded Mn²⁺ membrane is then oxidized by immersing it in the prepared oxidation solution for up to hours to incorporate HMO into the cation exchange membrane. After drying, the HMO-CEM can be activated by immersion in a solution comprising phosphate ions.

Further provided herein is a method for separating phosphate ions from a first aqueous solution comprising phosphate ions and non-phosphate ions, the method comprising:
contacting the first aqueous solution with a first side of an ion exchange membrane described herein;
contacting a second aqueous solution with a second side of the ion exchange membrane; and
applying a potential to a circuit comprising the first and second aqueous solutions such that phosphate ions flow from the first aqueous solution to the second aqueous solution.

In some embodiments, the phosphate ions flow selectively from the first aqueous solution through the ion exchange membrane and into the second aqueous solution.

In some further embodiments, the method includes activating the ion exchange membrane prior to contact it with the first and second aqueous solutions. For example, the method may comprise exposing the ion exchange membrane to a solution comprising phosphate ions prior to the contacting steps, thereby activating the ion exchange membrane.

The present invention, thus generally described, will be understood more readily by reference to the following examples, which are provided by way of illustration and are not intended to be limiting of the present invention

### Examples

Example 1. A process for forming the HMO-CEM. Hydrous manganese oxide (HMO) was loaded into a cation exchange membrane using a three step process. In the first step, a cation exchange membrane, in its dry form, was immersed in a solution containing 2.5 M MnCl₂•4H₂O and 3M MnSO₄•H₂O for up to 24 hours. As a result, Mn²⁺ ions in solution exchange with the H⁺ ions on the membrane according to the following equation:

$$2 {\text{RSO}}_{3} {}^{-} {\text{H}}^{+} + {\text{Mn}}^{2 +} \to {\left({\text{RSO}}_{3} -\right)}_{2} {\text{Mn}}^{2 +} + {\text{Na}}^{+}$$

The sodium ions are from the cationic exchange membrane and the “R” groups represent the polymer backbone of the cationic exchange membrane, which is a commercial exchange membrane. In the second step, an oxidation solution was prepared by dissolving NaOH in a Clorox® (NaOCl) solution to prepare a 1M NaOH solution with 7% available chlorine. The loaded Mn²⁺ membrane was then oxidized by immersing it in the prepared oxidation solution for up to 24 hours to provide the HMO:

$${\left({\text{RSO}}_{3} {}^{-}\right)}_{2} {\text{Mn}}^{2 +} \text{+NaOCl + NaOH} \to {\text{RSO}}_{3} \text{Na +} \text{} \text{HMO +} \text{} \text{NaCl}$$

Finally, the HMO-loaded CEM composite was washed with deionized water until a pH of 7 is reached with the washes. The HMO-CEM was then vacuum-dried at 50° C. for 18-24 hours. The prepared HMO-CEM was then immersed in a 0.5M NaH₂PO₄•H₂O solution, prior to experiments.

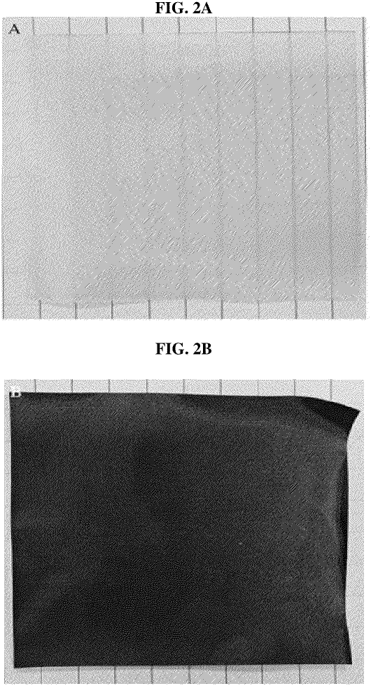

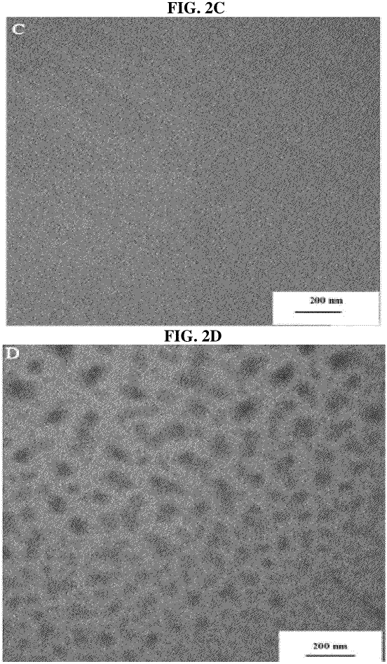

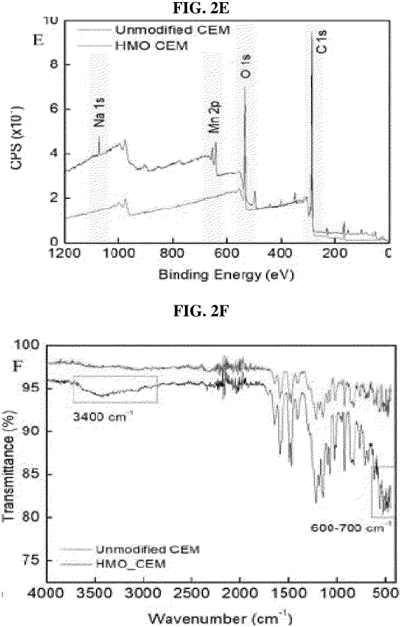

Example 2. Visual investigation of the membranes demonstrates the successful modification of the CEM with HMO. While the unmodified CEM is a white, slightly transparent material, the HMO-CEM is a solid-appearing black material. See FIGS. 2A and 2B. The structure and uniformity of the HMO immobilized within the membrane was investigated using transmission electron microscopy (TEM), and X-ray photoelectron spectroscopy (XPS). Cross-sectional TEM micrographs of the HMO-CEM clearly show the presence of HMO NPs distributed uniformly throughout the membrane, with an average size of approximately 79.4 ±23.1 nm, while TEM micrographs of the unmodified CEM show no distinguishing features. See FIGS. 2C and 2D. The XPS spectrum of the modified HMO-CEM shows a distinct Mn peak at about 642.8 eV, demonstrating the successful incorporation of Mn, at least at the surface of the material. See FIG. 2E and references 24 and 25. Fourier transform infrared spectroscopy (FTIR) peaks (See FIG. 2F) of the HMO-CEM show a weak broad band with a peak centered around 3400 cm-¹ resulting from the stretching vibrations of -OH following HMO loading, a broadening of a peak at 600 cm-¹, and two additional peaks at 712 cm⁻¹ and 681 cm⁻¹, corresponding to the MnOₓ stretching, bending, and wagging vibrations, respectively.(26, 27)

FIG. 2A is a photograph of unmodified CEM and B) HMO-CEM. Cross-sectional TEM micrographs for C) unmodified CEM and D) HMO-CEM show Mn nanoparticles embedded uniformly within the HMO-CEM matrix with an average particle size of ~79.4 ±23.1 nm. XPS spectra (E) show the Mn peak of the HMO-CEM at about 642.8 eV, demonstrating successful incorporation of Mn into the CEM; and FTIR spectra (F) shows a weak band at 3400 cm⁻¹ resulting from stretching of -OH, and peak broadening at 600-700 cm⁻¹ corresponding to MnOₓ stretching and bending vibrations.

Example 3. Phosphate transport across an unmodified CEM and HMO-CEM with two different HMO loadings, 117 mg Mn/g of membrane (concentration reached after soaking CEM in Mn solution for 24 hours) and 69 mg Mn/g of membrane (1 hour soaking time), shows that the transport rate is highly dependent on HMO loading.

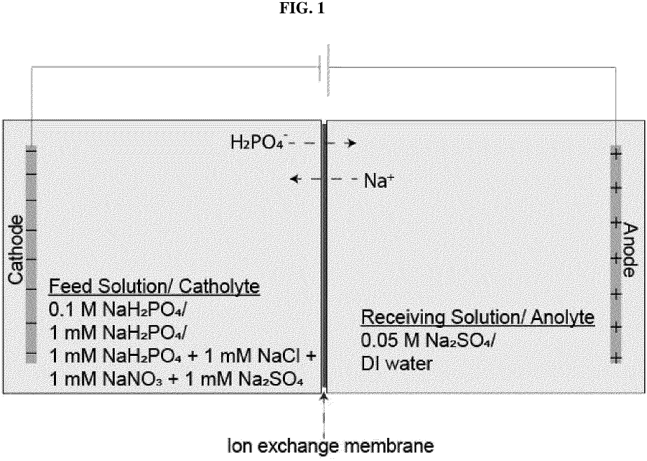

Unmodified CEMs and HMO-CEMs were evaluated for phosphate (and other ion) transport using diffusion cells operated in concentration-driven (Donnan dialysis) or concentration + field-driven (electrodialysis) mode as shown in FIG. 1. In all experiments, membranes were prepped by immersing in a 0.5 M NaH₂PO₄. H₂O solution for ~24 hours, followed by rinsing with DI water for 1 hour prior to the experiment. Experiments were conducted using either DI water or a 0.5 M Na₂SO₄ solution as the draw solution/anolyte. 2 ml of sample was collected hourly from each of the chambers and analyzed for the various ion concentrations and pH. Phosphate transport was studied by graphing the normalized phosphate concentration in the receiving compartment (y) as a function of time (x). The normalized concentration (y-axis) was the concentration increase in the receiving compartment normalized to the concentration of the chamber at the end of the first hour.

Phosphate transport across the modified and unmodified membranes was tested using the following configurations:

Phosphate transport via Donnan dialysis. For transport of phosphate across the HMO-CEM solely due to a concentration difference, the prepared fully loaded HMO-CEM membrane was placed in a diffusion cell where one chamber was filled with a 0.1 M NaH₂PO₄•H₂O solution, and the other side with a 0.05 MNa₂SO₄ solution.

Phosphate transport under an applied electric field (electrodialysis). For all experiments involving the application of electrical potentials as a driving force, Pt wires were used as both anode and cathode. For transport of phosphate under an externally applied field in addition to a concentration difference, the membrane (unmodified, low loading HMO-CEM, or fully loaded HMO-CEM) was placed in a diffusion cell where one chamber was filled with a 0.1 M NaH₂PO₄•H₂O solution (the catholyte), and the other side with either a 0.05 M Na₂SO₄ solution (the anolyte). A potential of 0.8 V vs. Ag/AgCl (applied on the cathode, 2V cell potential) was applied to the anode using a potentiostat (CH Instruments 6005E; Austin, TX).

Phosphate selectivity test. The selectivity of the membranes towards phosphate over other common anions was tested by placing the modified or unmodified in a diffusion cell separating a solution containing an equimolar (1 mM) solution of NaH₂PO₄•H₂O, Na₂SO₄, NaCl and NaNO₃ on one side (catholyte), and DI water on the other (anolyte). A potential of 0.8 V vs. Ag/AgCl (applied on the cathode; 2V cell potential) was applied across the membrane using a potentiostat. The effect of the competing ions on phosphate flux was studied by measuring phosphate flux in the absence of the competing ions. For this, a fully loaded HMO-CEM was placed in a diffusion cell where the catholyte was a 1 mM NaH₂PO₄•H₂O solution, and DI water was the anolyte. A potential of 0.8 V vs. Ag/AgCl (applied on the cathode, 2V cell potential) was applied to the anode using a potentiostat.

Phosphate concentration measurements. Phosphate ion concentrations were determined by two methods. For experiments involving only phosphate ions, a spectrophotometric method using colorimetric test kits (HACH TNT844) were utilized, while for experiments with mixed anions, an ion chromatograph (IC) was used (Dionex Integrion HPIC System, ThermoFisher). The flux, Jᵢ, of each anion was determined by calculating the slope of the concentration vs. time data generated during the transport experiments (m, moles/s), normalized by the membrane surface area (Aₘ):

$${J}_{ε} = \frac{m}{{A}_{m}} , {\text{mol/m}}^{2} / \text{s}$$

The separation factor of phosphate over other anions is expressed as a ratio of their individual fluxes since the starting upstream concentrations for all anions in our experiments were the same (1 mM); otherwise, separation factor is calculated as the ratio of flux normalized by the upstream concentration. (38)

$$\text{Separation factor =} \frac{F l u {x}_{p h o s p h a t e}}{F l u {x}_{a n i o n}}$$

Experimental transport numbers are calculated as the fraction of the overall current carried by the phosphate ion according to: (39, 40, 41)

$${t}_{{H}_{2} P {O}_{4}^{-}} = \frac{n F}{I t} * \left({C}_{0} {V}_{0} - {C}_{e n d} {V}_{e n d}\right)$$

where, n is the charge on the ion, F is Faraday’s constant (96485 C/mol), C₀ and C_{end} are the initial and final concentrations in the anodic compartment respectively, and V₀ and V_{end} are the initial and final volumes of the anodic compartment. The denominator is the average current (I, A) recorded over the duration of the experiment (t, s). The experimental transport numbers are reported over the time period with constant phosphate flux, giving us the maximum transport number.

Molecular modeling. In order to provide molecular-level insight into phosphate ions transport across and interaction with HMO-CEM, we carried out a series of molecular dynamics simulations for: i) NaH₂PO₄ electrolyte solution, ii) NaH₂PO₄ electrolyte solution in the presence of the HMO particle, iii) within the CEM membrane, and iv) within the composite HMO-CEM membrane. Prior to running molecular dynamics simulations, we have developed the interaction models (i.e., force-field parameters) for Nafion polymer and H2PO₄⁻ ions using the ab initio calculations. This step consisted of the geometry optimization, population analysis of the electron density to assign partial charges to atoms, and vibration analysis to determine force constants for bond stretching and angle bending dynamics. The ab initio calculations were carried out using the Density Functional Theory (B3LYP exchange-correlation function with 6-311++G** basis set) as implemented in the potential with parametrization taken from existing datasets. (42, 43, 44)

In the next step, we tested these force fields in the bulk water phase, which was modeled using rigid three-point water model OPC3. (45) We chose the OPC3 model because it accurately predicts solutes hydration environments and water dielectric properties. (44, 46) Finally, we constructed a polymeric membrane by randomly arranging 150 Nafion polymer molecules in the bulk water phase and allowing compaction using the Grand Canonical Monte Carlo scheme that gradually increases the polymer/water ratio via progressive dehydration. In the last step of preparation of the input configuration for molecular dynamics, we inserted H₂PO₄⁻ and Na⁺ ions into the water-saturated polymeric matrix. We have also generated a similar simulation system with an embedded spherical HMO particle (diameter ~ 10 nm). We used the pyrolusite crystal structure (47) to generate initial atomic coordinates for the HMO particle. The surface oxygen atoms were replaced by the hydroxyl groups resulting in the charge-neutral particle. The structure of the spherical HMO particle was allowed to relax at elevated temperature (T = 500 K) to resemble the less-ordered HMO particles in the HMO-CEM composite. To compare ions mobility in the system without Nafion, we prepared two additional simulation systems: H₂PO₄⁻ and Na⁺ ions immersed in water with and without the HMO particle.

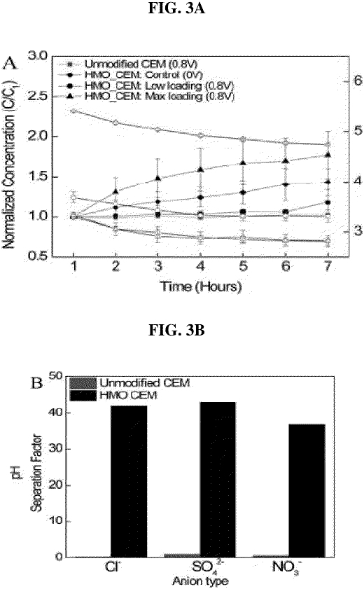

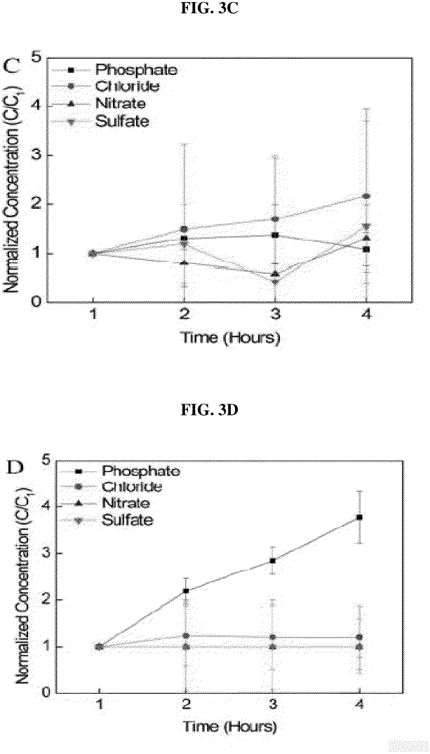

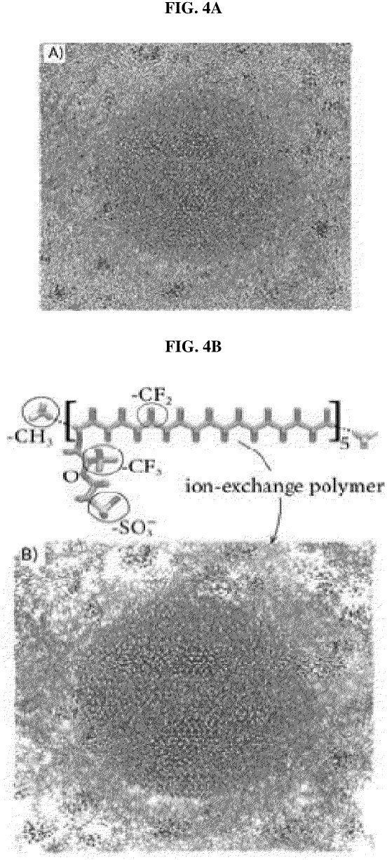

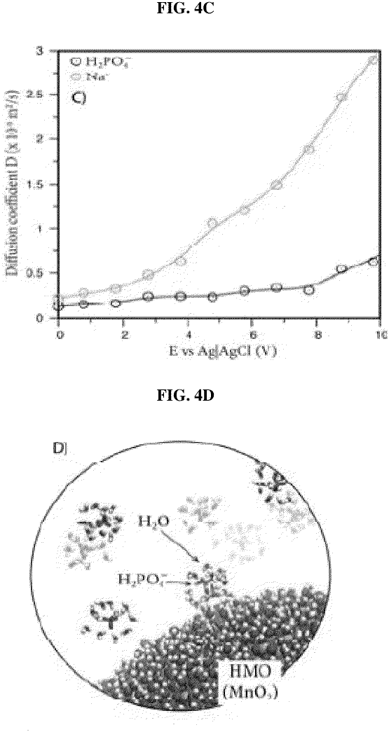

All simulations were carried out using an identical simulation protocol. The initial atom configurations were minimized using the mixture of the steepest descent and conjugate gradient minimization schemes. In all simulations, the number of water molecules and H₂PO₄⁻ were kept constant, which allows for the comparison of phosphate mobility under different conditions. The simulations were carried out with 150 H₂PO₄⁻ per 75000 water molecules (~ 2 mol/kg), and the fluid flux through the membrane and electrolysis of water were neglected. Next, the systems were brought to the desired temperature and density by heating for 200 ps in the canonical ensemble (NVT), followed by 25 ns simulation run in the isobaric-isothermal ensemble (NPT). The production simulations were carried out in the canonical ensemble for another 100 ns. The final production runs were carried out with and without the static electric field and repeated 10 times for each system composition and a given voltage from slightly different initial configurations of atoms. We analyzed the last 50 ns to gain insight into ion mobility and modes of interaction with the HMO-CEM membrane. The pressure was controlled using Berendsen barostat (48) with the pressure relaxation time equals 2 ps, whereas temperature was controlled using Langevin thermostat (49) with collision frequency equals 1.0 ps⁻¹. The molecular simulations were carried out using two GPU-optimized simulation engines: PMEMD simulation engine from Amber (50) and GMX-MDRUN from GROMACS. (51) The simulations of ion mobility within the HMO-CEM membrane under the influence of the electric field were carried out by applying a voltage across the cell with a magnitude identical of 0.8 V vs Ag|AgCl electrode. The voltage across the membrane is given by Vᵢ = Eᵢ Lᵢ (where Eᵢ is the electric field applied in i-direction, and Lᵢ is the length of the cell in i-direction. Because the size of the primary simulation cell used in molecular dynamics simulations is much smaller than the dimensions of the experimental cell, the effective electric field is adjusted according to the cell length in order to reproduce the experimental voltage. FIGS. 3A-B includes graphs of (3A) normalized phosphate concentration and pH in the permeate chamber for an unmodified CEM, high-loading HMO-CEM, and low-loading HMO-CEM in the presence and absence of an applied potential. The feed solution was composed of 0.1 M NaH₂PO₄, while 0.05M Na₂SO₄ was used as the receiving solution. A potential of 0.8 V vs. Ag/AgCl (2V cell potential) was applied across two Pt wires used as electrodes in the feed (cathode) and permeate (anode) chambers. (3B) Phosphate selectivity over competing anions (C1⁻, SO₄²⁻, and NO₃⁻) for an unmodified and HMO-CEM. Change in normalized concentration (C/C₁) in the permeate for the (3C) unmodified CEM, and (D) HMO-CEM for an equimolar solution (1mM) of NaCl, Na₂SO₄, NaNO₃, and NaH₂PO₄ as the feed solution, and 18 MΩ de-ionized water as the permeate; a potential of 0.8 V Vs Ag/AgCl (2V cell potential) was applied across two Pt wires used as electrodes in the feed (cathode) and permeate (anode) chambers. Error bars represent standard deviations.

To understand the interactions and transport of the ions through the HMO-CEM membrane on the molecular level, we carried out molecular dynamics simulations of H₂PO₄⁻ and Na⁺ ions in configurations that resemble the gel and intergel phases of the HMO-CEM. The all-atoms simulation protocol imposes a severe restriction on the size of the simulation cell. Consequently, the size of the embedded HMO particle and pore are scaled down compared to the experimental conditions. Specifically, the diameter of the simulated HMO particle is 10 nm, and the ions can explore the micro- and mesopore spaces of the HMO-CEM composite membrane. The system size is still sufficient to reveal the modes of interactions/complexation by polymer and particle and the molecular mechanism of phosphate transport through the HMO-CEM membrane. In FIGS. 3A-B, we show molecular snapshots of the HMO-CEM system and the molecular model of the model ion exchange polymer molecule.

The diffusion coefficients for the ions in the aqueous solution are representative of the intergel solution phase, whereas those along the HMO-CEM are representative of the gel phase. As can be seen, the calculated ion diffusivities in the gel phase are approximately three (H₂PO₄⁻) and two (Na⁺) times lower than their diffusivities inside the intergel solution phase. The presence of the HMO particle increases the mobility of phosphate by about 20%, but has a negligible effect on the mobility of sodium, whose mobility drops by 8%. The electric field accelerates the ionic mobility within the gel phase of HMO-CEM by 21% and 27% for phosphate and sodium ions, respectively.

The ions have the lowest mobility in the system composed of electrolyte solution in contact with the HMO particle. Phosphate ions adsorb at the HMO particle surface, forming outer-sphere complexes (FIG. 3D). The presence of the negatively charged polymeric matrix accelerates ion transport due to disruption of the weak electrical double layer formed around the HMO particle. Because the negatively charged polymeric matrix attracts Na⁺ and repels H₂PO₄⁻ ions, the Na⁺ ions are pulled away from the HMO vicinity, and H₂PO₄⁻ ions are pushed away from the polymer.

Without being bound by theory, H₂PO₄⁻ ion interaction with the particle weakens due to the depletion of Na⁺ ions around the HMO particle, and electrostatic attraction between H₂PO₄⁻ and Na⁺ions accumulated near negatively charged groups in the ion exchange polymer. As a result, the mobility of H₂PO₄⁻ increases nonlinearly in the gel phase of HMO-CEM compared to the cases of CEM or HMO-only systems. The nonlinearity is believed to be due to the complexity of the ion pathways across the HMO-CEM matrix. First, ion fluxes through the micro and mesopores differ due to the variation in the solvent properties, different proximity of the polymer chains and particle surfaces, and pore-size-dependent permeability. Second, an ion’s ability to diffuse against the field or in the direction perpendicular to the field decreases with increasing voltage. As the strength of the field increases, the thermal motion of ions diminishes, and the translation along the field lines dominates their dynamics. If the ion reaches the HMO surface, it can diffuse around it as an outer-sphere complex. However, if the ion becomes trapped in the dense polymer pocket with no exit channel, it will not escape by diffusing against the electric field lines. The voltage-dependent diffusivities (FIG. 3C) capture this phenomenon, showing subtle deviation from the expected exponential dependence. While the diffusivities of the individual phosphate ions vary in any given simulation, the simulation shows that the slowest ions are moving through the polymeric channels while the fastest move through the intergel solution phase or near the HMO particles. The molecular dynamics simulations provide a molecular-level understanding of phosphate transport through the HMO-CEM membrane. Simulations confirm experimental observations that H₂PO₄⁻ ions are forming only outer-sphere complexes with HMO, enabling their uptake onto the HMO-CEM material, and facilitating their diffusion across the membrane. This transport is driven by an electric field or concentration gradient across the membrane. The simulations also confirm that phosphate mobility is much higher in the HMO-CEM compared to the pure CEM.

FIGS. 1A-D: Example of the simulation cell used in the molecular dynamics simulations—- a spherical HMO particle embedded in the ion exchange polymeric matrix saturated with an aqueous solution containing H₂PO₄- and Na⁺ ions (1A). the simulation cell with water molecules and Na⁺ ions hidden (1B). The voltage-dependent diffusion coefficients of ions in the gel phase in a direction parallel to the electric field as calculated from the molecular dynamics trajectory (1C). Outer-spherically adsorbed H₂PO₄⁻ ions on the surface of a HMO particle (Na+, polymer, and water molecules except for H₂PO₄-hydration shells are hidden) (1D).

Using our experimental observations, a model describing ion transport across the HMO-CEM was developed based on the micro heterogeneous model for ion exchange membranes.(30, 31) The model was used to predict the flux and transport number for phosphate, and was then used to estimate the HMO loading needed to increase phosphate transport across the membrane.

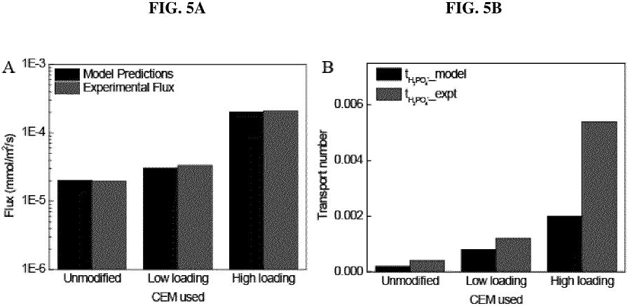

Since hydration of a polymeric membrane leads to the formation of micro and meso-pores, which swell strongly as water intercalates between the polymeric chains within the membrane,(33) it is possible that the modification of the membrane by the in situ growth of HMO NPs affects the internal membrane structure and changes the α parameter, and by extension, the concentration profile of co-ions within the membrane (the n-parameter). By adjusting the parameters n and α to 5 and 0.3, respectively, the predicted flux for the high-loading HMO-CEM membrane matched the experimental flux (FIG. 5A).

The ion transport numbers predicted by the model were compared to those obtained from the experiments in FIG. 5B. Transport numbers describe the fraction of current carried by a particular ion species relative to the overall current passing through the system. For the case of phosphate transport across unmodified and modified CEMs, the transport numbers predicted by the model are lower for all three membranes compared to the experiment, particularly for the high-loading HMO-CEM. This can be attributed to the simplifying assumptions used to account for sodium and proton transport during the experiments. However, in all cases the model predicts that the addition of HMO to the CEM matric increases the fraction of current carried by phosphate.

The model predicts a higher gel-phase diffusion coefficient for anions over cations, by nearly two orders of magnitude (Table 1). This could be attributed to the electrostatic attraction between cations and the polymeric fixed charges, which the anions/co-ions do not experience.(34) While this may seem counter-intuitive (since the flux of cations is much higher than that of anions), the higher flux can be explained by Donnan exclusion, which causes counter ions to partition into the membrane at a higher rate than co-ions, resulting in higher counter ion concentrations within the membrane. Thus, cations are transported across by interaction with the fixed charges in the gel phase of the membrane, while the anions are transported through the electroneutral solution present in the intergel phase and the cation and anion transport are correlated (coupled) to maintain charge-neutrality of the fluid phase. In the HMO phase, the diffusion coefficient of phosphate is higher than that of cations. Importantly, the interactions of phosphate ions with the HMO particles enables their partitioning into and diffusion across the HMO-CEM, resulting in a higher diffusion coefficient for the phosphate anions. As a result, phosphate is transported across the membrane through the intergel phase by ‘hopping’ along the HMO NPs.

Finally, the model was used to estimate the HMO loading that would yield a phosphate flux comparable to phosphate flux through an anion exchange membrane. Increasing the HMO loading of a CEM affects its properties including water uptake, ion exchange capacity, the diffusion coefficient of salt through the membrane, and the volume fraction occupied by the NPs within the membrane. However, since most of these values were obtained from experiments and used as inputs into the model, extrapolating the model to accurately predict phosphate flux at higher HMO loading is riven with uncertainty.

Table 1

Results from the microheterogenous model

| | ${C}_{c o}^{g}$ | ${C}_{c t}^{g}$ | ${D}_{c o}^{g}$ | ${D}_{c t}^{g}$ | ${D}_{c o}^{H M O}$ | ${D}_{c t}^{H M O}$ | ${t}_{{H}_{2} P {O}_{\overline{4}}}$ |
|---|---|---|---|---|---|---|---|
| | [mM] | [M] | [m2/s] | [m2/s] | [m2/s] | [m2/s] | |
| Unmodified | 0.24 | 4.49 | 3.00×10⁻⁹ | 2.65×10⁻¹¹ | -- | -- | 0.0002 |
| Low-loading | 0.35 | 3.07 | 3.01×10⁻⁹ | 3.87×10⁻¹¹ | 5.85×10⁻⁹ | 5.89×10⁻⁹ | 0.0008 |
| High-loading | 0.62 | 2.91 | 3.03×10⁻⁹ | 4.06×10⁻¹¹ | 5.82×10⁻⁹ | 5.84×10⁻⁹ | 0.002 |

Where C^{g}_{co} and C^{g}_{ct} are the co- and counter-ion concentrations at the membrane/feed interface, D^{g}_{co} and D^{g}_{ct} are the co- and counter-ion diffusivities in the gel-phase, and D^{HMO}_{co} and D^{HMO}_{ct} are the diffusivities of the co- and counter-ions along the HMO nanoparticles.

In this study, we successfully synthesized, characterized, and tested a new class of membranes that allow for selective transport of phosphate across a cation exchange membrane. Selective separation is achieved by exploiting the outer-sphere complexation reaction between phosphate and the embedded HMO NPs within the membrane.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

References and Notes
1. D. T. Jackson, P. N. Nelson. J. Mol. Struct. 1182, 241-259 (2019).
2. A. A. Uliana, N. T. Bui, J. Kamcev, M. K. Taylor, J. J. Urban, J. R. Long. Science. 372, 296-299 (2021).
3. L. Paltrinieri. React. Funct. Polym. 133, 126-135 (2018).
4. Y. Zhou, C. Hu, H. Liu, J. Qu. Environ. Sci. Technol. 54, 4592-4600 (2020).
5. A. Tor. J. Hazard. Mater. 141, 814-818 (2007).
6. C. M. Khor, X. Zhu, M. S. Messina, S. Poon, X. Y. Lew, H. D. Maynard, D. Jassby. ACS Mater. Lett. 1, 647-654 (2019).
7. M. Elimelech, W. A. Phillip. Science (80-. ). 333 (2011), pp. 712-717.
8. L. Paltrinieri. Environ. Sci. Technol. 53, 2396-2404 (2019).
9. S. M. Harris. Environ. Sci. Technol. 51, 4549-4558 (2017).
10. R. Liu, L. Chi, X. Wang, Y. Wang, Y. Sui, T. Xie, H. Arandiyan. Chem. Eng. J. 357, 159-168 (2019).
11. B. Pan, J. Wu, B. Pan, L. Lv, W. Zhang, L. Xiao, X. Wang, X. Tao, S. Zheng. Water Res. 43, 4421-4429 (2009).
12. B. Pan, F. Han, G. Nie, B. Wu, K. He, L. Lu. Environ. Sci. Technol. 48, 5101-5107 (2014).
13. R. D. Noble, C. A. Koval. Mater. Sci. Membr. Gas Vap. Sep., 411-435 (2006).
14. Y. Li, S. Wang, G. He, H. Wu, F. Pan, Z. Jiang. Chem. Soc. Rev. 44, 103-118 (2015).
15. C. Tang, M. L. Bruening. J. Polym. Sci. 58, 2831-2856 (2020).
16. M. I. G. S. Almeida, R. W. Cattrall, S. D. Kolev. J. Memb. Sci. 415-416, 9-23 (2012).
17. Y. M. Scindia, A. K. Pandey, A. V. R. Reddy. J. Memb. Sci. 249, 143-152 (2005).
18. M. V. Ramakrishnam Raju. Chem. Soc. Rev. 49, 1090-1108 (2020).
19. N. Y. Acelas, B. D. Martin, D. López, B. Jefferson. Chemosphere. 119, 1353-1360 (2015).
20. Y. Fransiscus, R. K. Widi, G. O. Aprilasti, M. D. Yuharma. Int. J. Adv. Sci. Eng. Inf. Technol. 8, 818-824 (2018).
21. W. Yao, F. J. Millero. Environ. Sci. Technol. 30, 536-541 (1996).
22. M. Kawashima, Y. Tainaka, T. Hori, M. Koyama, T. Takamatsu. Water Res. 20, 471-475 (1986).
23. S. Mustafa, M. I. Zaman, S. Khan. Chem. Eng. J. 141, 51-57 (2008).
24. H. W. Nesbitt, D. Banerjee. Am. Mineral. 83, 305-315 (1998).
25. Z. Yang, J. Gong, C. Tang, W. Zhu, Z. Cheng, J. Jiang, A. Ma, Q. Ding. J. Mater. Sci. Mater. Electron. 28, 17533-17540 (2017).
26. S. J. Parikh, J. Chorover. Geomicrobiol. J. 22, 207-218 (2005).
27. X. Wang, L. Andrews. J. Phys. Chem. A. 110, 10035-10045 (2006).
28. I. Stenina, D. Golubenko, V. Nikonenko, A. Yaroslavtsev. Int. J. Mol. Sci. 21, 1-33 (2020).
29. E. Jashni, S. M. Hosseini, J. N. Shen, B. Van der Bruggen. Ionics (Kiel). 25, 5595-5610 (2019).
30. M. Porozhnyy. Int. J. Hydrogen Energy. 41, 15605-15614 (2016).
31. B. Zhang, H. Gao, C. Xiao, X. Tong, Y. Chen. J. Memb. Sci. 597, 117751 (2020).
32. R. S. Kingsbury, O. Coronell. J. Memb. Sci. 620, 118411 (2020).
33. N. Kononenko. Adv. Colloid Interface Sci. 246, 196-216 (2017).
34. M. Lopez, B. Kipling, H. L. Yeager. Anal. Chem. 49, 629-632 (1977).
35. T. Rottiers. J. Memb. Sci. 492, 263-270 (2015).
36. N. White.ACS Appl. Mater. Interfaces. 7, 6620-6628 (2015).
37. S. M. Hosseini. Desalination. 341, 107-114 (2014).
38. Luo, H., Agata, W. A. S. & Geise, G. M. Connecting the Ion Separation Factor to the Sorption and Diffusion Selectivity of Ion Exchange Membranes. Ind. Eng. Chem. Res. 59, 14189-14206 (2020).
39. Larchet, C., Auclair, B. & Nikonenko, V. Approximate evaluation of water transport number in ion-exchange membranes. Electrochim. Acta 49, 1711-1717 (2004).
40. Fuller, T. F. & Newman, J. Experimental Determination of the Transport Number of Water in Nafion 117 Membrane. J. Electrochem. Soc. 139, 1332-1337 (1992).
41. Chakrabarty, T. et al. Stable ion-exchange membranes for water desalination by electrodialysis. Desalination 282, 2-8 (2011).
42. Li, P. & Merz, K. M. Metal Ion Modeling Using Classical Mechanics. Chem. Rev. 117, 1564-1686 (2017).
43. Wang, J., Wolf, R. M., Caldwell, J. W., Kollman, P. A. & Case, D. A. Development and testing of a general Amber force field. J. Comput. Chem. 25, 1157-1174 (2004).
44. Li, Z., Song, L. F., Li, P. & Merz, K. M. Systematic Parametrization of Divalent Metal Ions for the OPC3, OPC, TIP3P-FB, and TIP4P-FB Water Models. J. Chem. Theory Comput. 16, 4429-4442 (2020).
45. Izadi, S. & Onufriev, A. V. Accuracy limit of rigid 3-point water models. J. Chem. Phys. 145, (2016).
46. Zarzycki, P. & Gilbert, B. Temperature-dependence of the dielectric relaxation of water using non-polarizable water models. Phys. Chem. Chem. Phys. 22, 1011-1018 (2020).
47. R. W. G. Wyckoff. Crystal Structures. Mineral. Mag. 4, (1968).
48. Berendsen, H. J. C., Postma, J. P. M., Van Gunsteren, W. F., Dinola, A. & Haak, J. R. Molecular dynamics with coupling to an external bath. J. Chem. Phys. 81, 3684-3690 (1984).
49. Goga, N., Rzepiela, A. J., De Vries, A. H., Marrink, S. J. & Berendsen, H. J. C. Efficient algorithms for langevin and DPD dynamics. J. Chem. Theory Comput. 8, 3637-3649 (2012).
50. D.A. Case, S.R. Brozell, D.S. Cerutti, T.E. Cheatham, V.W.D. Cruzeiro, T.A. Darden, R.E. Duke, D. Ghoreishi, H. Gohlke, A.W. Goetz, D. Greene, R. Harris, N. Homeyer, S. Izadi, A. Kovalenko, T.S. Lee, S. LeGrand, L.B. Li, C. Lin, J. Liu, T. Luchko, R. Luo, P. A. K. AMBER 2018. San Fr. Univ. Calif. (2018).
51. Berendsen, H. J. C., van der Spoel, D. & van Drunen, R. GROMACS: A message-passing parallel molecular dynamics implementation. Comput. Phys. Commun. 91, 43-56 (1995).

1. An ion exchange membrane comprising a cation exchange membrane having hydrous manganese oxide nanoparticles incorporated therein.

2. The ion exchange membrane of claim 1, wherein the ion exchange membrane comprises from about 25 to about 250 mg of manganese per gram of the cation exchange membrane.

3. The ion exchange membrane of claim 1, wherein the ion exchange membrane comprises from about 50 to about 150 mg of manganese per gram of the cation exchange membrane.

4. The ion exchange membrane of claim 1, wherein the hydrous manganese oxide nanoparticles have an average particle size of from about 25 to about 250 nanometers.

5. The ion exchange membrane of claim 1, wherein the hydrous manganese oxide nanoparticles have an average particle size of from about 50 to about 150 nanometers.

6. The ion exchange membrane of claim 1, wherein the ion exchange membrane comprises a gel phase and an intergel phase.

7. The ion exchange membrane of claim 1, wherein the ion exchange membrane comprises pores.

8. The ion exchange membrane of claim 1, wherein the ion exchange membrane is selective for the passage of phosphate ion.

9. The ion exchange membrane of claim 1, wherein the ion exchange membrane is selective for the passage of phosphate ion under concentration-driven conditions or field-driven conditions.

10. The ion exchange membrane of claim 1, wherein the ion exchange membrane is at least 30 times more selective for phosphate over chloride, nitrate, or sulfate.

11. The ion exchange membrane of claim 1, wherein the cation exchange membrane comprises; a) a polymeric backbone having anionic groups attached thereto; and b) positive counterions.

12. The ion exchange membrane of claim 11, wherein the anionic groups are covalently bound to the polymeric backbone.

13. The ion exchange membrane of claim 11, wherein the anionic groups comprise sulfonate ions.

14. The ion exchange membrane of claim 11, wherein the positive counterions are selected from Li, Na, K, Mn, Cs, and any combination thereof.

15. A method of making the ion exchange membrane of claim 1, comprising the steps of:
a) exposing a cation exchange membrane to an aqueous solution comprising manganese ions;
b) exposing the cation exchange membrane to an alkaline oxidizing solution, thereby forming the ion exchange membrane comprising hydrous manganese oxide nanoparticles; and
c) washing the ion exchange membrane comprising hydrous manganese oxide nanoparticles with an aqueous washing solution to achieve a neutral pH.

16. The method of claim 15, wherein step b) incorporates the hydrous manganese oxide nanoparticles into the cation exchange membrane.

17. The method of claim 15, wherein the alkaline oxidizing solution comprises aqueous NaOH and NaOC1.

18. The method of claim 15, wherein the aqueous washing solution is water.

19. The method of claim 15, further comprising drying the ion exchange membrane after step c).

20. A method for separating phosphate ions from a first aqueous solution comprising phosphate ions and non-phosphate ions, the method comprising:
contacting the first aqueous solution with a first side of the ion exchange membrane of claim 1;
contacting a second aqueous solution with a second side of the ion exchange membrane; and
applying a potential to a circuit comprising the first and second aqueous solutions such that phosphate ions flow from the first aqueous solution to the second aqueous solution.

21-22. (canceled)
